(19) United States
(12) Patent Application Publication
(10) Pub. No.: US 2023/0409984 A1
(43) Pub. Date: Dec. 21, 2023

(54) INFORMATION PROCESSING DEVICE, METHOD, AND MEDIUM

(71) Applicant: Rakuten Group, Inc., Tokyo (JP)

(72) Inventor: Xu WANG, Tokyo (JP)

(73) Assignee: Rakuten Group, Inc., Tokyo (JP)

(21) Appl. No.: 18/336,260

(22) Filed: Jun. 16, 2023

(30) Foreign Application Priority Data
Jun. 21, 2022 (JP) 2022-099545

(51) Int. Cl. G06N 20/20

(52) U.S. Cl. CPC G06N 20/20

(57) ABSTRACT

An information processing device includes a first effect estimating unit for obtaining a first causality score indicating an effect that a predetermined operation has on a user, by inputting an attribute of the user to a first model, a second effect estimating unit for obtaining a second causality score indicating the effect, by inputting the attribute of the user to a second model, a calibration function deciding unit for deciding a calibration function for calibration of the first causality score, based on the first causality score and the second causality score calculated for each of a plurality of users, and a third effect estimating unit for deciding a third causality score indicating the effect on an object user, by applying the first causality score, which is calculated with regard to the object user, to the calibration function.

### CROSS-REFERENCE TO RELATED APPLICATION(S)

This application claims priority to and the benefit of Japanese Patent Application No. 2022-099545, filed on Jun. 21, 2022, the disclosure of which is expressly incorporated herein by reference in its entirety for any purpose.

### FIELD

The present disclosure relates to technology for scoring effects of operations on users.

### BACKGROUND

Operations of dunning for payment of credit card debt, i.e., for debt collection, have conventionally been performed by operators in call centers who place telephone calls to customers, and so forth (see Japanese Patent Application Publication No. 2001-282994). There also is known dunning support technology in which operators change the tone of uttering example text used for dealing with customers in accordance with the time of day when the dunning work is being carried out (see Japanese Patent Application Publication No. 2010-224617).

### SUMMARY

Using a machine learning model in order to perform scoring of effects that predetermined operations have on users is conceivable. However, in a case in which learning processing of the machine learning model is performed in a strongly dependent manner on action tendencies and/or results of users in the past, there is a possibility that this model will not be able to accurately predict future scores.

With the foregoing in view, it is an object of the present disclosure to improve precision of scoring of effects that operations have on users.

An example of the present disclosure is an information processing device that includes: first effect estimating means for obtaining a first causality score indicating an effect that a predetermined operation has on a user, by inputting an attribute of the user to a first model; second effect estimating means for obtaining a second causality score indicating the effect, by inputting the attribute of the user to a second model of which a bias is smaller and a variance is greater as compared to the first model; calibration function deciding means for deciding a calibration function for calibration of the first causality score, based on the first causality score and the second causality score calculated for each of a plurality of users; and third effect estimating means for deciding a third causality score indicating the effect on an object user, by applying the first causality score, which is calculated with regard to the object user, to the calibration function.

The present disclosure can be comprehended as being a method executed by an information processing device, a system, or a computer, or as a program executed by a computer. The present disclosure can also be comprehended as being an arrangement where such a program is recorded in a recording medium that is readable by a computer or other device, machine, or the like. A recording medium that is readable by a computer or the like as used here refers to a recording medium where information such as data, programs, and so forth, is accumulated by electrical, magnetic, optical, mechanical, or chemical action, and can be read by a computer or the like.

According to the present disclosure, precision of scoring of effects that operations have on users can be improved.

### BRIEF DESCRIPTION OF THE DRAWINGS

FIG. 1 is a schematic diagram illustrating a configuration of an information processing system according to an embodiment;

FIG. 2 is a diagram schematically illustrating a functional configuration of an information processing device according to the embodiment;

FIG. 3 is a diagram showing an overview of a configuration in which a causality score output from a relatively high-bias and low-variance model is calibrated with reference to output by a relatively low-bias and high-variance model in the embodiment;

FIG. 4 is a diagram showing an overview of processing for deciding a calibration function using a first causality score and a second causality score in the embodiment;

FIG. 5 is a diagram showing a simplified concept of a decision tree of a machine learning model employed in the embodiment;

FIG. 6 is a diagram showing a relation between effects and risks that are estimated, and operation conditions, in the embodiment;

FIG. 7 is a flowchart showing a flow of machine learning processing according to the embodiment;

FIG. 8 is a flowchart showing a flow of calibration function deciding processing according to the embodiment;

FIG. 9 is a flowchart showing a flow of third causality score estimation processing according to the embodiment;

FIG. 10 is a flowchart showing a flow of operation conditions output processing according to the embodiment;

FIG. 11 is a flowchart showing a flow of a variation (1) of the operation conditions output processing according to the embodiment; and

FIG. 12 is a flowchart showing a flow of a variation (2) of the operation conditions output processing according to the embodiment.

### DESCRIPTION OF EMBODIMENTS

An embodiment of an information processing device, a method, and a program, according to the present disclosure, will be described below with reference to the figures. However, the embodiment described below is an example, and does not limit the information processing device, the method, and the program according to the present disclosure, to specific configurations described below. When being carried out, specific configurations are employed in accordance with the embodiment, and various types of improvements and modifications may be made.

In the present embodiment, an embodiment will be described regarding a case of carrying out the technology according to the present disclosure for an operation center managing system for dunning regarding payment of credit card usage amounts of which payments are late, and collecting debt. It should be noted, however, that systems to which the technology according to the present disclosure is applicable are not limited to operation center managing systems for dunning regarding payment of credit card usage amounts. The technology according to the present disclosure is broadly applicable to technology for scoring effects that operations have on users, and objects of application of the preset disclosure are not limited to examples given in the embodiment. Neither are the types of operations to which the technology according to the present disclosure is applicable, nor the types of effects on the users, limited to examples given in the embodiment.

Normally, payment of a credit card usage amount is performed by a method such as withdrawal from an account of a user on a withdrawal data every month, the user making a deposit by a specified date, or the like, but there are cases in which payment of the credit card usage amount is not completed by a stipulated date, due to a reason such as insufficient funds in the account of the user, the user not making a deposit by the specified data, or the like. Accordingly, operations are conventionally performed such as an operation center (call center) placing telephone calls, performing message transmission, or the like, to the customer, thus performing dunning with respect to the user for payment of the credit card usage amount, in order to collect the debt.

Generally, operations directed to users are effective in order to avoid default (non-fulfilment of obligation), and the more the volume of operations is increased, the more the debt collection rate rises. However, meanwhile, the more the volume of operations is increased, the more the costs for operations, such as labor expenditures, system usage fees, system maintenance fees, and so forth, increase. Accordingly, with the foregoing problem in view, the system according to the present disclosure employs technology for suppressing costs relating to operations without lowering the debt collection rate. Note that while description will be made in the present embodiment by way of an example in which a predetermined operation primarily is placing a telephone call to a user, the content of the predetermined operation is not limited, and may be various types of operations for prompting the user to perform a predetermined action.

Configuration of System

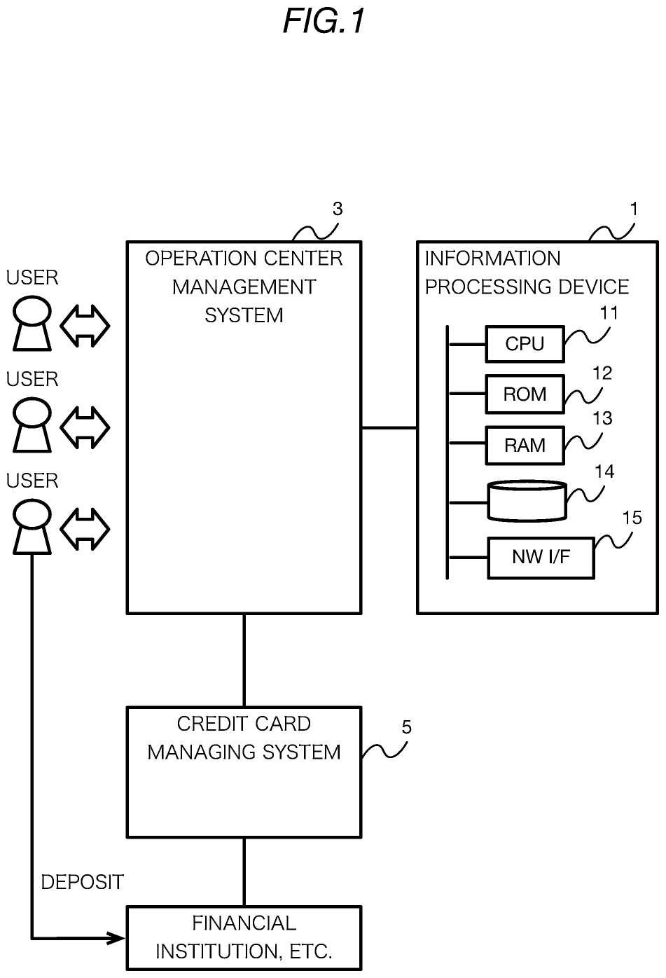

FIG. 1 is a schematic diagram illustrating a configuration of an information processing system according to the present embodiment. In the system according to the present embodiment, an information processing device 1, an operation center management system 3, and a credit card managing system 5 are connected so as to be mutually communicable. An operation terminal (omitted from illustration) for performing operations following instructions from the operation center management system 3 is installed in an operation center, and an operator operates the operation terminal to carry out operations directed to a user. The user is a credit card user who deposits a credit card usage amount via a financial institution or the like, and payment history data of the credit card usage amount is notified to the operation center management system 3 via the credit card managing system 5.

The information processing device 1 is an information processing device for outputting data for controlling operations by the operation center management system 3. The information processing device 1 is a computer that includes a central processing unit (CPU) 11, read-only memory (ROM) 12, random-access memory (RAM) 13, a storage device 14 such as electrically erasable and programmable read-only memory (EEPROM), a hard disk drive (HDD), or the like, a communication unit 15 such as a network interface card (NIC) or the like, and so forth. Note, however, that with regard to the specific hardware configuration of the information processing device 1, omissions, substitutions, and additions may be made as appropriate, in accordance with the embodiment. Also, the information processing device 1 is not limited to a device made up of a single casing. The information processing device 1 may be realized by a plurality of devices, using so-called cloud or distributed computing technology or the like.

The operation center management system 3, the credit card managing system 5, and the operation terminal are each a computer including a CPU, ROM, RAM, a storage device, a communication unit, an input device, an output device, and so forth (omitted from illustration). Each of these systems and terminal is not limited to a device made up of a single casing. These systems and terminal may be realized by a plurality of devices, using so-called cloud or distributed computing technology or the like.

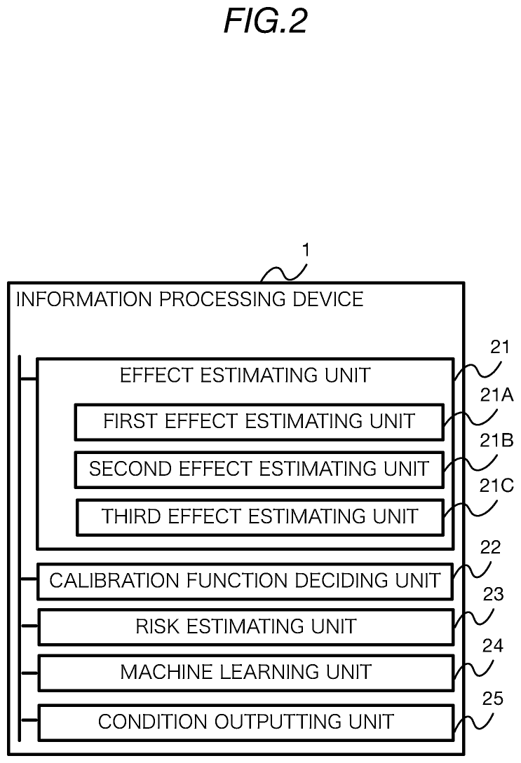

FIG. 2 is a diagram schematically illustrating a functional configuration of the information processing device 1 according to the present embodiment. In the information processing device 1, a program recorded in the storage device 14 is read out to the RAM 13 and executed by the CPU 11, and each piece of hardware included in the information processing device 1 is controlled, thereby functioning as an information processing device including an effect estimating unit 21, a calibration function deciding unit 22, a risk estimating unit 23, a machine learning unit 24, and a condition outputting unit 25. Note that in the present embodiment and other embodiments that will be described later, the functions that the information processing device 1 has are executed by the CPU 11, which is a general-use processor, but part or all of these functions may be executed by one or a plurality of dedicated processors.

The effect estimating unit 21 estimates the effects that a predetermined operation, directed to a user to prompt the user to execute a predetermined action, will have on whether or not the user executes the action. In the present embodiment, the predetermined action is payment of a credit card usage amount regarding which payment is late. Note that the specific payment means is not limited, and may be a transfer to a specified account, payment at a specified teller window, or the like. Also, in the present embodiment, the predetermined operation is a telephone call placed for dunning regarding payment of the credit card usage amount regarding which payment is late. Note that the telephone call placed to the user may be an automated telephone call using a recording or machine-generated voice, or may be a telephone call in which an operator (human) converses with the user. Further, in the present embodiment, the effect estimating unit 21 estimates the effects of the operation, using a machine learning model that outputs a causality score (causality score) indicating, with respect of input of one or a plurality of user attributes relating to an object user, the effects of the operation directed to this user.

Now, a machine learning model that outputs causality scores can be generated using a machine learning framework based on ensemble learning and a machine learning framework based on a gradient boosting decision tree, for example. However, although this depends on the machine learning framework, training data, and other conditions, bias and variance are generally in a tradeoff relation in machine learning models, and there has been a tendency for output of machine learning models to be high-bias and low-variance in calculation of causality scores.

Accordingly, a system according to the present embodiment enables more accurate scoring regarding causality scores to be performed, by employing a configuration in which causality scores output from a relatively high-bias and low-variance model to be calibrated by referencing output from a relatively low-bias and high-variance model that decides causality scores in accordance with actual collection rates or default rates.

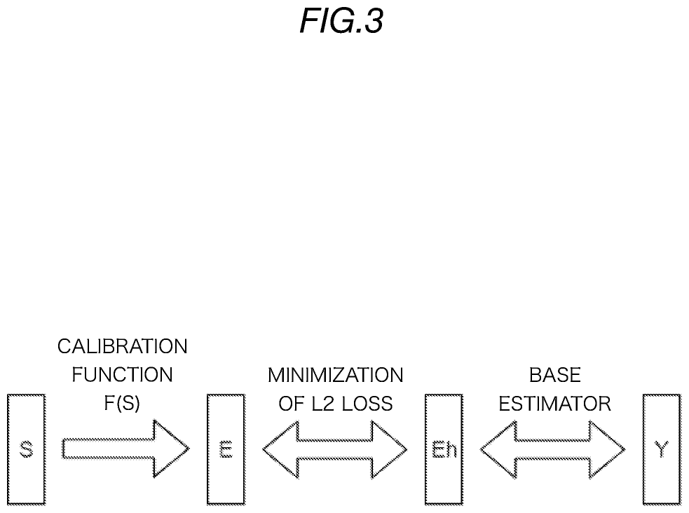

FIG. 3 is a diagram showing an overview of a configuration in which a causality score output from a relatively high-bias and low-variance model is calibrated with reference to output by a relatively low-bias and high-variance model in the present embodiment. Referencing FIG. 3, it can be seen that a calibration function is used for this calibration in the present embodiment that
(1) calibrates a first causality score S output from a relatively high-bias and low-variance model into a third causality score E that is more precise (relatively low-bias and high-variance), and that
(2) further reduces (if possible, minimizes) a difference (e.g., L2 loss) between a second causality score Eh output from a relatively low-bias and high-variance model generated based on a label Y indicating whether or not actually collected, which each user is imparted with (base estimator), and the first causality score S that is relatively high-bias and low-variance. Note that although an example of L2 loss is used for description of evaluation of error between predicted values and correct answer values in the preset embodiment, the evaluation method of error is not limited, and other evaluation methods may be employed.

In order to execute the above-described processing and obtain the third causality score E as the final output by the effect estimating unit 21, in the present embodiment the effect estimating unit 21 includes a first effect estimating unit 21A for obtaining the first causality score S that is relatively high-bias and low-variance, a second effect estimating unit 21B for obtaining the second causality score Eh that is relatively low-bias and high-variance, and a third effect estimating unit 21C for obtaining the third causality score E that is relatively low-bias by calibrating the first causality score (see FIG. 2).

The first effect estimating unit 21A inputs attributes of a user into a first model, and thereby obtains the first causality score S indicating effects that a predetermined operation will have on the user. As described above, the bias (imbalance) of the first model according to the present embodiment is relatively great, and accordingly the first causality score S output from the first model is calibrated by the third effect estimating unit 21C, which will be described later.

The second effect estimating unit 21B obtains the second causality score Eh that manifests effects by inputting the attributes of the user into a second model in which bias (imbalance) is smaller and variance (dispersion) is greater than in the first model. Any model can be employed as the second model here as long as the bias is smaller and the variance is greater than in the first model, and the configuration of models that can be employed as the second model is not limited.

In the present embodiment, an example in which a model in which a histogram is used to estimate the causality score (histogram window estimator) is employed as the second model (base estimator) will be described. In the present embodiment, the second model is generated by a method of assigning a plurality of users to a plurality of bins (n bins here) in a histogram in accordance with attributes of each of the users, and calculating, for each bin, the causality score corresponding to the user group assigned to that bin. The second effect estimating unit 21B then identifies, based on attributes of an object user of which estimation of the causality score is desired, a bin corresponding to the object user in the second model (histogram), and identifies the causality score calculated with regard to the identified bin as being the second causality score Eh of this object user. Accordingly, the second model is neither a smooth function, unlike a later-described calibration function, nor a monotonic function, but the second causality score Eh that is low-bias can be obtained by this second mode.

Now, the causality score corresponding to the user group assigned to each bin is generated by a method of calculating the causality score based on statistics relating to an execution rate of an action by users subjected to an operation, out of a plurality of users having an attribute corresponding to this bin, and statistics relating to the execution rate of the action by users not subjected to the operation out of the plurality of users, based on a label Y, indicating whether or not actual collection resulted, imparted to each user. In the present embodiment, the difference between a default rate P1 serving as statistics relating to an execution rate of the action by users subjected to the operation, and a default rate P0 serving as statistics relating to the execution rate of the action by users not subjected to the operation, is taken as the second causality score Eh (Eh=P0−P1).

The third effect estimating unit 21C applies the first causality score S calculated with regard to the object user to the calibration function F(x), thereby deciding the third causality score E (E=F(S)) indicating the effects with regard to this object user. Note that while processing contents of the function used by the third effect estimating unit 21C are described using the expression “calibration” in the present disclosure, processing contents of this function may include regularization, normalization, modification, and so forth.

The calibration function deciding unit 22 decides, based on the first causality score S and the second causality score Eh calculated with regard to each of the plurality of users, the calibration function for calibration of this first causality score S.

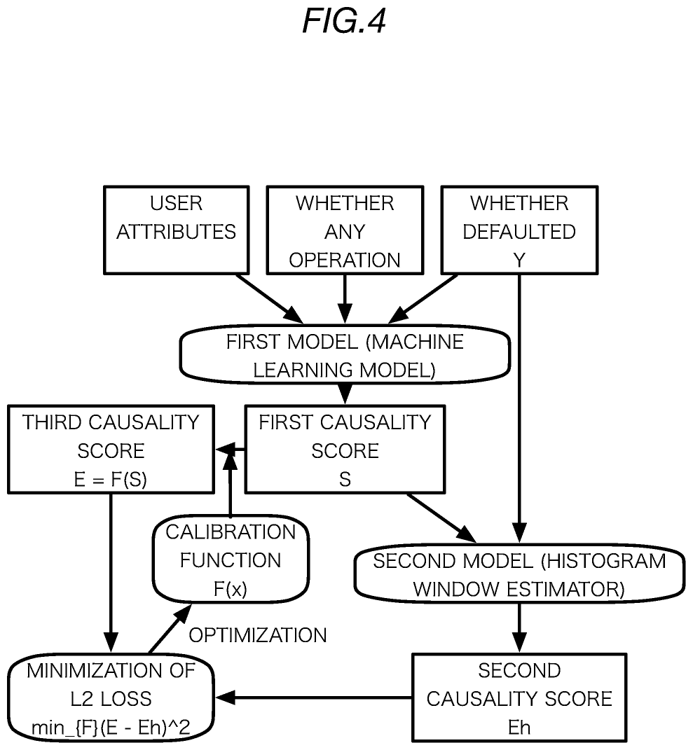

FIG. 4 is a diagram showing processing for deciding the calibration function using the first causality score and the second causality score in the embodiment. The calibration function deciding unit 22 decides the calibration function and parameters of this calibration function such that the difference (e.g., L2 loss) between the third causality score E obtained by applying the first causality score S to the calibration function and the second causality score Eh is smaller (if possible, minimized) so that (L2 loss=min_{F} (E−Eh)\hat{ }2) holds, in other words, such that the third causality score E becomes closer to the second causality score Eh through the calibration.

To describe this by way of an example of a linear function “F(x)=a*x+b” the calibration function deciding unit 22 decides the parameters a and b such that the difference (e.g., L2 loss) between the third causality score E obtained by applying the first causality score S to the calibration function and the second causality score Eh is smaller (if possible, minimized) so that (L2 loss=min_{a, b}(aS+b−Eh)\hat{ }2) holds. Note that while the linear function “F(x)=a*x+b” has been given as an example of the calibration function here, the type and the number of parameters of the calibration function are not limited. For example, the calibration function deciding unit 22 may hold formats for a plurality of types of functions in advance, identify the function format by which approximation is realized based on the difference between the third causality score E and the second causality score Eh, and thereafter search for parameters (coefficients) within the function format such that the loss is small. Also, for example, an arrangement may be made in which the calibration function deciding unit 22 references an approximation function of the first causality score S that is generated based on the first causality score S and an approximation function of the second causality score Eh generated based on the second causality score Eh, finds a function by which the approximation function of the first causality score S can be transformed into the approximation function of the second causality score Eh, and decides this function to be the calibration function.

In the present embodiment, a function that is a smooth function and also is a monotonic function may be used as the calibration function. Due to the calibration function being a smooth function and also a monotonic function, a ranking of users decided based on the first causality score S (order based on causality rank) can be maintained before and after application of the calibration function, and a situation in which the order of users is switched before and after calibration can be prevented. A smooth function may, for example, refer to a differentiable function, may refer to a continuously differentiable function, may refer to a k-th order continuously differentiable function (k=1, 2, . . . ), may refer to a function in which a derivative function is a continuous function, may refer to a piecewise differentiable function, or may refer to a function that is continuously differentiable with regard to a predetermined n. A monotonic function may, for example, refer to a monotonic increasing function or a monotonic decreasing function in which a function value constantly increases or decreases in accordance with increase or decrease of a variable, or may refer to a function in which a function value increases or decreases in accordance with increase or decrease of a variable within a predetermined range.

The risk estimating unit 23 estimates risk based on the probability that the user will not execute the above-described predetermined action. The representation method of the risk is not limited, and various indices may be employed, but for example, the risk can be expressed using the odds of the debt defaulting without being collected. Further, in the preset embodiment, the risk estimating unit 23 estimates risk based on the probability that the user will not execute the action, using a machine learning model that, in response to input of one or a plurality of user attributes regarding the object user, outputs a risk index indicating the odds of the debt regarding this user defaulting without being collected. Note, however, that risk may be estimated following predetermined rules, for example, without using a machine learning model. For example, the risk may be acquired by holding in advance a value that corresponds to user attributes or each combination of user attributes, and reading out this value. Also, an index other than the odds of defaulting may be employed for the index indicating the risk. For example, the risk may be classified (ranked), and which class (rank) the class (rank) is may be used as the index.

The machine learning unit 24 generates and/or updates the machine learning model used for effect estimation by the effect estimating unit 21 and the machine learning model used for risk estimation by the risk estimating unit 23. The machine learning model for effect estimation is a machine learning model that, in a case of data of one or a plurality of user attributes relating to the object user is input, outputs a causality score indicating the extent of effects of the operation directed to the user. Also, the machine learning model for risk estimation is a machine learning model that, in a case of data of one or a plurality of user attributes relating to the object user being input, outputs a risk index indicating the degree of risk based on the probability that the user will not execute the action. User attributes input to these machine learning models may include, for example, demographic attributes, behavioral attributes, or psychographic attributes. Now, examples of demographic attributes are the sex (gender) of the user, family makeup, age, and so forth, examples of behavioral attributes are whether or not a cash advance user, whether or not a revolving credit user, deposit/withdrawal history regarding a predetermined account, history of transactions relating to some sort of product including gambling or lotteries (may include online transaction history in an online marketplace or the like), and so forth, and examples of psychographic attributes are tendencies relating to gambling or lotteries, and so forth. Note, however, that attributes of users that can be used are not limited to those exemplified in the present embodiment. For example, “time required for operation (placing a telephone call, etc.)” and “credit card usage amount” may also be used as attributes.

When generating and/or updating the machine learning model (first model in the present embodiment) for effect estimation, the machine learning unit 24 creates the machine learning model based on training data (data for machine learning), in which is defined, as a causality score indicating the effects of the operation directed to users having predetermined attributes, a score based on statistics relating to the rate of execution of the action (debt collection rate) by users who received the operation out of a plurality of users having these attributes, and a score based on statistics relating to the rate of execution of the action by users who did not receive the operation out of the plurality of users, for each attribute of the user. In the present embodiment, in a case in which the content of the operation is placing a telephone call to a user as an example, a causality score based on difference between the statistics is calculated, by an expression of “(debt collection rate in case of user telephoned)−(debt collection rate in case of user not telephoned)”, the calculated causality score is combined with corresponding attribute data of the user, and input to the machine learning unit 24 as training data. Note that in the present embodiment, description will be made by way of an example of using average values as statistics. However, statistical indices such as, for example, modal value, median value, or the like, may be used as statistics. Here, statistics regarding the rate of execution of the action may be based on the past debt collection rate within a predetermined period (e.g., a predetermined month) for each user. Also, in the present embodiment, the causality score based on difference between the statistics is to be calculated, but in cases in which no statistically significant difference is found in this difference, the causality score may be set to zero or approximately zero. Now, known statistical techniques may be employed for this determination regarding whether or not there is a significant difference. For example, standard error and confidence interval may be taken into considerations regarding sets of average collection rate of the user for each month, to take into consideration statistical significance regarding change in collection rate in accordance with whether or not telephone calls were placed. Thus, the causality score can be calculated taking into consideration variance in average collection rate among users within the same group.

In creating the training data, a user who has been telephoned once can never be a user who was not telephoned thereafter, so with regard to one user, only one of a collection rate in a case in which the user was telephoned and a collection rate when not telephoned can be acquired. Accordingly, training data for effects of placing telephone calls is created for each group of users having common attributes. That is to say, the causality score indicating the effects of placing telephone calls with respect to a user group made up of users having a certain common attribute is acquired by, for example, dividing the plurality of users having this common attribute into a first sub-user group that was telephoned and a second sub-user group that was not telephoned, each of an average value of debt collection rate from the first sub-user group that was telephoned and an average value of debt collection rate from the second sub-user group that was not telephoned is calculated, and calculating the difference between these average values in collection rate by the above-described expression. For example, in a case in which the average value of debt collection rate from the first sub-user group that was telephoned is 80%, and the average value of debt collection rate from the second sub-user group that was not telephoned is 70%, the causality score indicating the effects of placing telephone calls to these user groups is “10”.

A framework for generating machine learning models that can be employed in carrying out the technology according to the present disclosure is based on an ensemble learning algorithm, as an example. A machine learning framework (e.g., LightGBM) based on a gradient boosting decision tree (Gradient Boosting Decision Tree: GBDT), for example, may be employed for this framework. In other words, for this framework, a machine learning framework that is based on a decision tree model in which error between correct answers and predicted values is carried over between weak learners (weak classifiers) before and after, may be employed. Predicted values here refers to predicted values of causality scores or risk indices, as examples. Note that besides LightGBM, boosting techniques such as XGBoost, CatBoost, and so forth, may be employed in this framework. According to frameworks using decision trees, machine learning models that have relatively high performance can be generated with little parameter adjustment effort as compared to frameworks using neural networks. It should be noted, however, that the framework for generating machine learning models that can be employed in carrying out the technology according to the present disclosure is not limited to that exemplified in the present embodiment. For example, instead of the gradient boosting decision tree, another learner, such as random forest or the like, may be employed as the learner, and a learner that is not referred to as a so-called weak learner, such as a neural network and so forth, may be employed. Also, in a case of employing a learner that is not referred to as a so-called weak learner, such as a neural network and so forth, ensemble learning does not have to be employed.

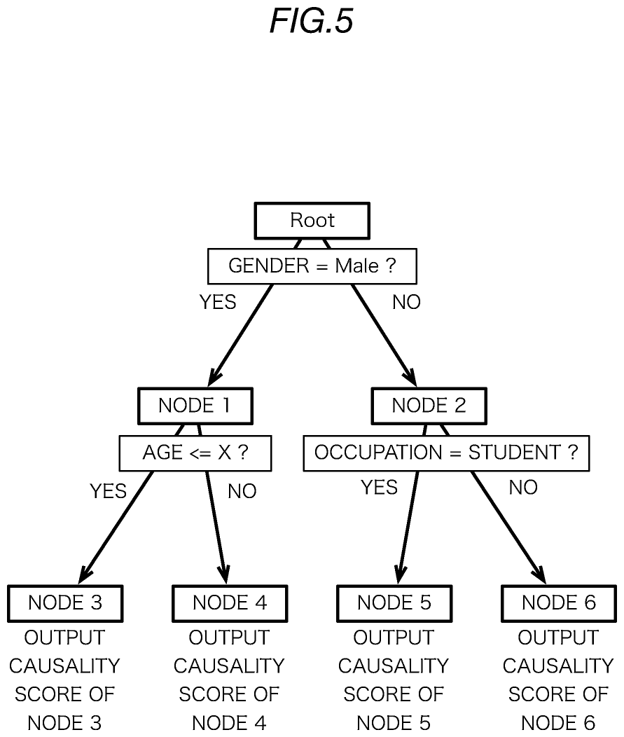

FIG. 5 is a diagram showing a simplified concept of a decision tree of the machine learning model employed in the present embodiment. In a case of employing a machine learning framework with gradient boosting based on a decision tree algorithm, optimization of the branching condition of each node of the decision tree is performed. Specifically, in a machine learning framework with gradient boosting based on a decision tree algorithm, causality scores indicating effects of an operation are calculated for each of user groups having attributes indicated by each of two child nodes branched from one parent node, and the branching condition of the parent node is optimized such that the difference of these causality scores is great (e.g., such that the difference is maximal, or is no less than a predetermined threshold value), which is to say, such that the two child nodes are clearly branched. For example, in a case in which the attribute indicated as the branching condition of a node is age, the age set as the threshold value for branching may be changed, the branching condition may be changed to an attribute other than age, or the like. Thus, recursively optimizing the branching conditions of all nodes of the decision tree enables estimation precision of effects of the operation to be improved.

When generating and/or updating the machine learning model for risk estimation, the machine learning unit 24 creates the machine learning model based on training data, in which is defined statistics relating to the rate of default occurring for a plurality of users having a predetermined attribute (Average value in the present embodiment. However, statistical indices such as, for example, modal value, median value, or the like, may be used.), as a risk index indicating the degree of risk of users having this attribute, for each attribute of the user. The calculated risk index is combined with corresponding attribute data of the user, and is input to the machine learning unit 24 as training data. Also, the framework for the machine learning model generation that can be employed is not limited in generating or updating of the machine learning model for risk estimation as well, and a machine learning framework with gradient boosting based on a decision tree algorithm may be employed, in the same way as in generating and/or updating the machine learning model for effect estimation described above.

The condition outputting unit 25 decides and outputs conditions relating to an operation to be executed at the operation center regarding the user (hereinafter referred to as “operation conditions”), based on the estimated effects and risk (in the present embodiment, causality score and risk index). In the present embodiment, operation conditions may be at least any one of whether or not there is need to execute operations, the count of times of execution of the operations, the order of execution of the operations, means of contacting the user in the operations, and contents at the time of contacting the user in the operations. Here, examples of means of contacting include placing telephone calls, performing message transmission, and so forth, and contents at the time of contacting include contents to be communicated to the user when placing a telephone call and contents described in a message.

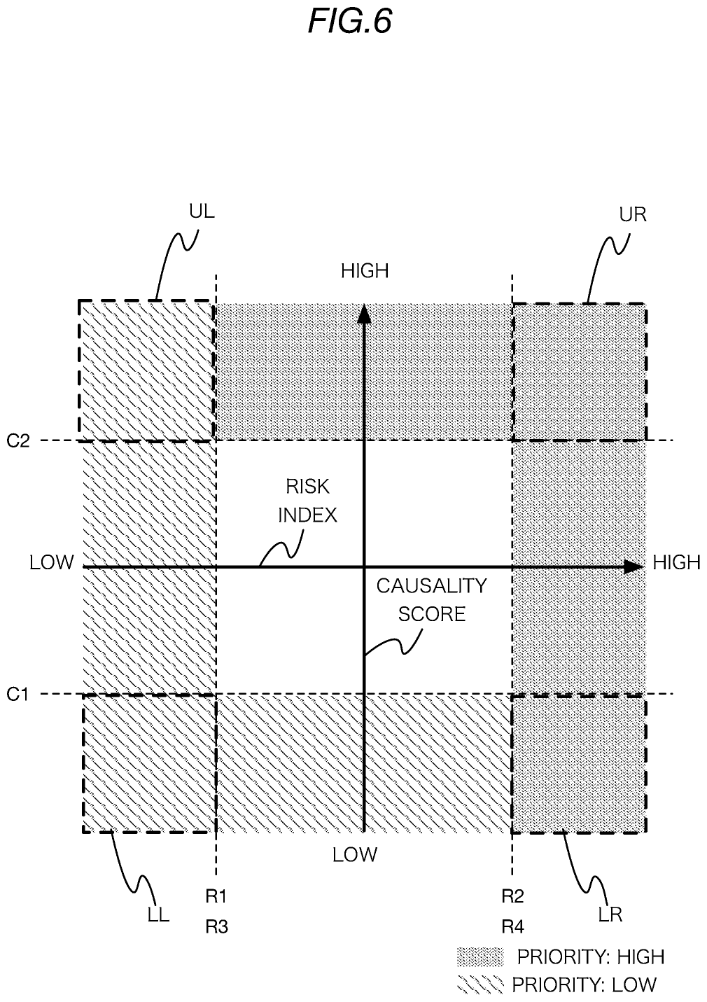

FIG. 6 is a diagram showing a relation between effects and risks that are estimated, and operation conditions, in the present embodiment. Basically, the condition outputting unit 25 outputs operation conditions that yield higher priority with regard to at least part of operations directed to users with higher estimated effects, and operations directed to users with higher estimated risks. Also, the condition outputting unit 25 outputs operation conditions that yield lower priority with regard to at least part of operations directed to users with lower estimated effects, and operations directed to users with lower estimated risks.

Priority here is a measure of the degree of operations being performed with priority, which is set with respect to users or operations directed to the users. The higher the priority of a user is, the higher the possibility or frequency of receiving an operation is, and the lower the priority of a user is, the lower the possibility or frequency of receiving an operation is. Specifically, the condition outputting unit 25 outputs, as conditions yielding a higher priority, operation conditions in which this operation is set to execution required, the count of times of execution of this operation is increased, the order of execution of this operation is moved up, or the means of contacting the user or the content of contact in this operation is changed to that with higher costs or effects. Also, the condition outputting unit 25 outputs, as conditions yielding a lower priority, operation conditions in which this operation is set to execution not required, the count of times of execution of this operation is decreased, the order of execution of this operation is moved down, or the means of contacting the user or the content of contact in this operation is changed to that with lower costs or effects.

In the present embodiment, the condition outputting unit 25 compares the estimated causality score and risk index with threshold values set in advance regarding each of the causality score and risk index, and decides and outputs operation conditions in accordance with the results of comparisons. Specifically, in the example shown in FIG. 6, a threshold value C1, and a threshold value C2 that is greater than the threshold value C1, are set for the causality score, and a threshold value R1 (first threshold value), and a threshold value R2 (second threshold value) that is greater than the threshold value R1, are set for the risk index. Also, with respect to the risk index, a threshold value R3 for segregating between whether or not to be an object of setting operation conditions in accordance with causality score, and a threshold value R4 for determining users to be the object of being set with operation conditions with high priority, regardless of causality score, are further set. Note that in the present embodiment, description will be made regarding an example in which the same value is used for the threshold values R1 and R3, and the same value is used for the threshold values R2 and R4 (see FIG. 6), but different values may be used for each of these threshold values.

Now, cases in which operation conditions with high priority are output will be described.

Case (1): The condition outputting unit 25 decides and outputs operation conditions with high priority with regard to at least part of users of which the causality score is the threshold value C2 or higher, since effects of the operation are high.

Case (2): Also, the condition outputting unit 25 decides and outputs operation conditions with high priority with regard to at least part of users of which the risk index is the threshold value R2 or higher, since the risk is high.

Case (3): In particular, the condition outputting unit 25 may decide and output operation conditions with highest priority with regard to users of which the causality score is the threshold value C2 or higher and also the risk index is the threshold value R2 or higher (see region UR indicated by dashed lines in FIG. 6).

Case (4): Note however, that the condition outputting unit 25 does not have to output operation conditions that would yield a high priority for users regarding which the estimated risk index is lower than the threshold value R3, since the possibility of defaulting is low to begin with. In a case in which raising cost suppression effects is desired, operation conditions with low priority or operation conditions with mid-level priority are preferably decided and output for users regarding which the risk index is lower than the threshold value R3, regardless of causality score (region UL indicated by dashed lines in FIG. 6 has a causality score of C2 or higher, but the risk index is lower than R3, and accordingly is not the object of operation conditions with high priority). Accordingly, the effect estimating unit 21 may estimate effects of the operation with regard to users of which the risk index is estimated to be the threshold value R3 (third threshold value) or higher, and not estimate effects of the operation (omit estimation processing) with regard to users of which the risk index is estimated to be lower than the threshold value R3 (third threshold value).

Also, cases in which operation conditions with low priority are output will be described.

Case (5): The condition outputting unit 25 decides and outputs operation conditions with low priority with regard to at least part of users of which the causality score is lower than the threshold value C1, since effects of the operation are low.

Case (6): Also, the condition outputting unit 25 decides and outputs operation conditions with low priority with regard to at least part of users of which the risk index is lower than the threshold value R1, since the risk is low.

Case (7): In particular, the condition outputting unit 25 may decide and output operation conditions with lowest priority with regard to users of which the causality score is lower than the threshold value C1 and also the risk index is lower than the threshold value R1 (see region LL indicated by dashed lines in FIG. 6).

Case (8): Note however, that the condition outputting unit 25 does not have to output operation conditions that would yield a lower priority for users regarding which the estimated risk index is the threshold value R4 or higher, since the possibility of defaulting is high to begin with. Preferably, operation conditions with high priority are decided and output for users regarding which the risk index is the threshold value R4 or higher, regardless of causality score (region LR indicated by dashed lines in FIG. 6 has a causality score of lower than C1, but the risk index is R4 or higher, and accordingly is not the object of operation conditions with low priority).

Accordingly, in the example shown in FIG. 6, the operation priority is raised for high-risk users, and mid-risk and high-effect users, and the operation priority is lowered for low-risk users, and mid-risk and low-effect users. Note that in the above-described example, description is made regarding an example in which regions are sectioned based on threshold values, and common operation conditions are decided for users belonging to a given region, but different operation conditions may be set for each user in a given region, or for each user. For example, operation conditions may be made to differ with a gradient in accordance with the height of causality score and/or risk index, even within the same region.

Note that the volume of operations (the total count of operations and the count of users who are the object of operations) by the operation center management system 3 can be changed by adjusting the above-described threshold values. For example, the volume of operations can be increased by lowering at least one or more of the threshold value C1, the threshold value C2, the threshold value R1, and the threshold value R2, and the volume of operations can be reduced by raising at least one or more of the threshold value C1, the threshold value C2, the threshold value R1, and the threshold value R2.

Flow of Processing

Next, the flow of processing executed by the information processing system according to the present embodiment will be described. Note that the specific contents and processing orders described below are an example for carrying out the present disclosure. Specific processing contents and processing order can be selected as appropriate, in accordance with the embodiment of the present disclosure.

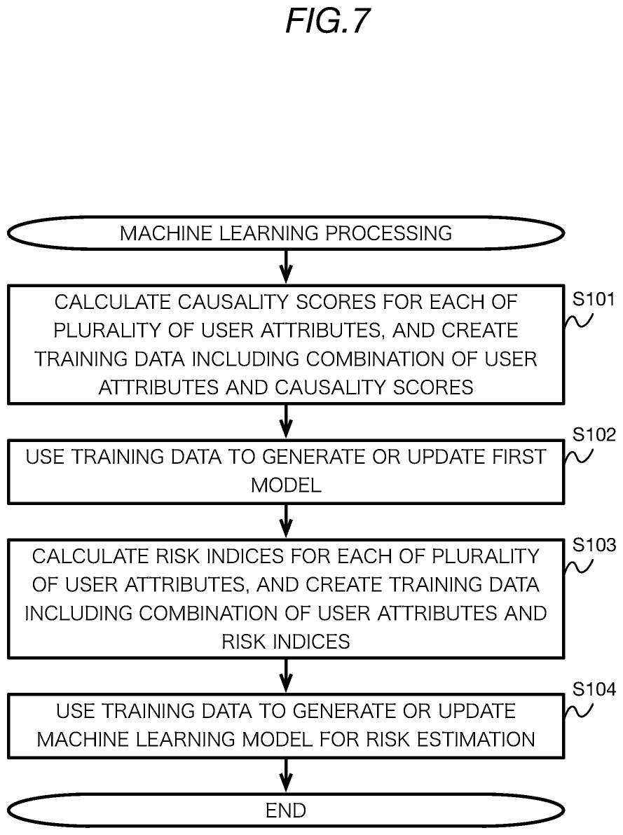

FIG. 7 is a flowchart showing a flow of machine learning processing according to the present embodiment. The processing shown in this flowchart is executed at a timing specified by an administrator of the operation center management system 3.

In steps S101 and S102, a machine learning model used for effect estimation is generated and/or updated. The machine learning unit 24 calculates the causality scores for each of a plurality of user attributes, based on attribute data of users, operation history data, and payment history data of credit card usage amount, accumulated in the past in the operation center management system 3 or the credit card managing system 5, and creates training data that includes a combination of user attributes and causality scores (step S101). Here, the operation history data includes data that enables comprehension, with respect to each user, whether or not an operation was performed directed to that user, and the payment history data includes data that enables comprehension, with respect to each user, whether or not there was payment of the credit card usage amount (whether or not defaulting) of that user. The machine learning unit 24 then inputs the created training data into the machine learning model, and the machine learning model (first model) used for effect estimation by the first effect estimating unit 21A is generated or updated (step S102). Subsequently, the processing advances to step S103.

In steps S103 and S104, a machine learning model used for risk estimation is generated and/or updated. The machine learning unit 24 calculates the risk indices for each of a plurality of user attributes, based on attribute data of users, operation history data, and payment history data of credit card usage amount, accumulated in the past in the operation center management system 3 or the credit card managing system 5, and creates training data that includes a combination of user attributes and risk indices (step S103). The machine learning unit 24 then inputs the created training data into the machine learning model, and the machine learning model used for risk estimation by the risk estimating unit 23 is generated or updated (step S104). Subsequently, the processing shown in this flowchart ends.

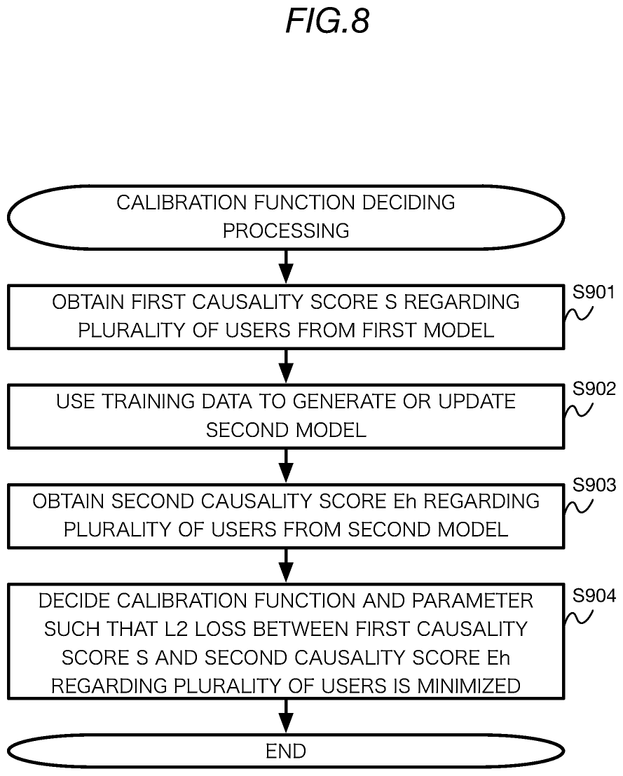

FIG. 8 is a flowchart showing the flow of calibration function deciding processing according to the present embodiment. The processing shown in this flowchart is executed at a timing specified by the administrator of the operation center management system 3.

In step S901, the first causality score S is obtained. The first effect estimating unit 21A inputs, with respect to each of the plurality of users, data of user attributes to the first model generated and/or updated in the machine learning processing described with reference to FIG. 7, and obtains the first causality score S corresponding to each of the plurality of users, as output from the first model. The first model here is a model that is trained with training data from a certain period in the past or earlier (e.g., up to last month), and the first causality score S that is output of this model is output of the model trained with training data from the certain period in the past or earlier. Subsequently, the processing advances to step S902.

In steps S902 and S903, the second causality score Eh is obtained. The information processing device 1 generates or updates the second model by a method of assigning the plurality of users to each of the plurality of bins in the histogram in accordance with attributes of each of the users, and calculates, for each bin, causality scores corresponding to the user groups assigned to that bin (step S902). Now, generating or updating of the second model is performed using fact data (labels indicating whether or not defaulting, etc.) in the most recent period (e.g., this month). Upon the second model being generated or updated, the second effect estimating unit 21B inputs attributes of the plurality of users to the second model, thereby obtaining the second causality score Eh corresponding to each of the plurality of users (step S903). Accordingly, the second causality score Eh is output that is based on the fact data from the most recent period. Subsequently, the processing advances to step S904.

In step S904, the calibration function is decided. The calibration function deciding unit 22 decides the calibration function and the parameters such that the L2 loss between the first causality score S and the second causality score Eh regarding the plurality of users is made to be smaller (if possible, minimized). As described above, the first causality score S is output of the model trained by training data from the certain period in the past or earlier, and the second causality score Eh is output based on fact data of the most recent period. Accordingly, the calibration function can correct the first causality score S estimated based on data from the past (e.g., up to last month), based on current (e.g., this month) fact data that is more accurate. Subsequently, the processing shown in this flowchart ends.

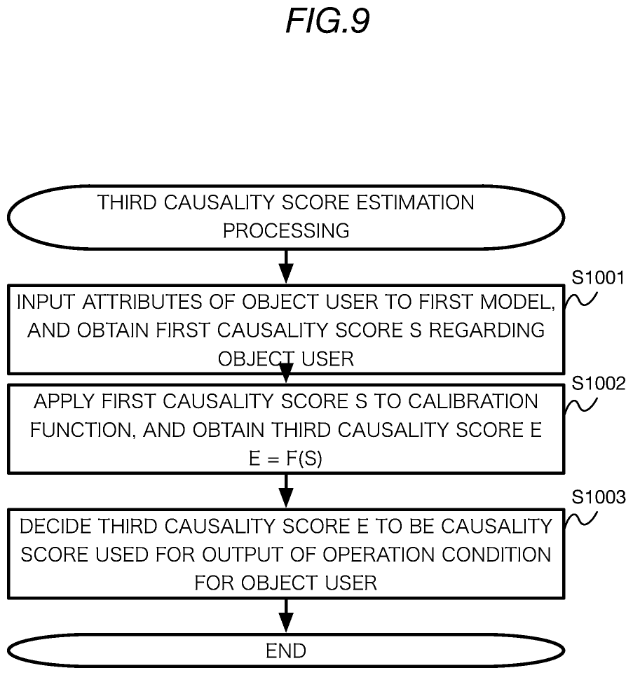

FIG. 9 is a flowchart showing a flow of third causality score estimation processing according to the present embodiment. The processing shown in this flowchart is executed at a timing set in advance each month. More specifically, the execution timing of the processing is set to a timing that is after the payment stipulation data for the credit card usage amount, and also before a scheduled date for execution of operations directed to delinquent users.

In step S1001, the first causality score S is obtained. The first effect estimating unit 21A inputs, for each of the plurality of users, data of one or a plurality of user attributes relating to the object user, to the first model generated and/or updated in the machine learning processing described with reference to FIG. 7, and obtains the first causality score S corresponding to this user as output from this first model. The processing then advances to step S1002.

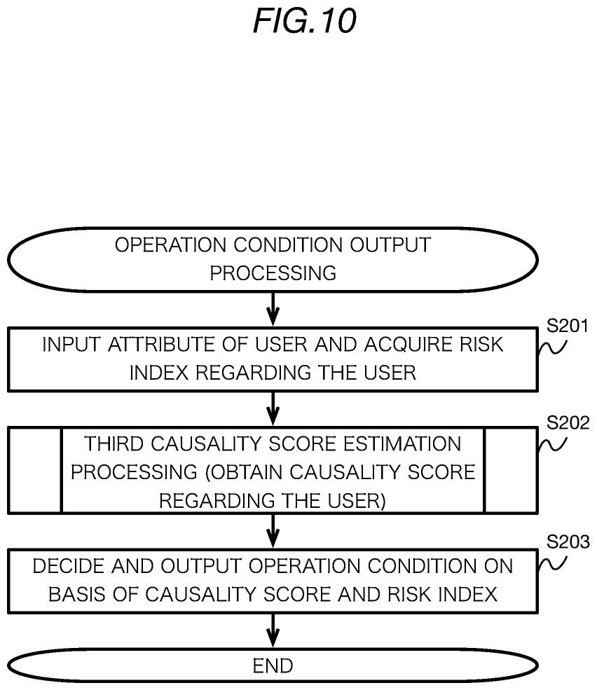

In steps S1002 and S1003, a causality score used for output of operation conditions is decided. The third effect estimating unit 21C applies the first causality score S calculated with regard to the object user in step S1001 to the calibration function F(x), thereby deciding the third causality score E (E=F(S)) with regard to this object user (step S1002). The effect estimating unit 21 decides the third causality score E calculated in step S1002 as the causality score to be used for output of operation conditions for the object user in operation conditions output processing described later with reference to FIG. 10 (step S1003). Subsequently, the processing shown in this flowchart ends.

FIG. 10 is a flowchart showing the flow of the operation conditions output processing according to the present embodiment. The processing shown in this flowchart is executed at a timing set in advance each month. More specifically, the execution timing of the processing is set to a timing that is after the payment stipulation data for the credit card usage amount, and also before a scheduled date for execution of operations directed to delinquent users.

In step S201 and step S202, effects of operations, and risk based on the probability of users not executing actions, are estimated. The risk estimating unit 23 inputs data of one or a plurality of user attributes relating to object users to the machine learning model generated and/or updated in step S104, for each of a plurality of users, and acquires risk indices corresponding to the users, as output from the machine learning model (step S201). Also, the effect estimating unit 21 executes the third causality score estimating processing described with reference to FIG. 9, thereby obtaining, for each of a plurality of users, causality scores corresponding to object users (step S202). Subsequently, the processing advances to step S203.

In step S203, operation conditions are decided and output. The condition outputting unit 25 decides operation conditions based on the causality scores and the risk indices estimated in step S201 and step S202, and outputs these to the operation center management system 3. In the present embodiment, the condition outputting unit 25 identifies and outputs operation conditions mapped to causality scores and risk indices in advance. Note however, that the decision method of operation conditions is not limited to the exemplification in the present embodiment. For example, operation conditions may include values calculated by inputting causality scores and risk indices to a predetermined function. Subsequently, the processing shown in this flowchart ends.

Upon operation conditions being output, the operation center management system 3 manages operations regarding the object users following the operation conditions, and the operation terminal executes operations following the instructions output by the operation center management system 3.

Effects

According to the present embodiment, more accurate scoring can be realized by performing calibration of estimation results of causality scores. Also, according to the present invention, rapid behavior change can be handled by using a calibration function that is more simplified than the machine learning model itself, and scoring technology that is capable of prompt response to behavior change of users can be realized.

Further, according to the present embodiment, setting priorities of operation conditions in accordance with operation effects and risks for each user, and suppressing operations to users with low effects or risks enables costs regarding operations to be suppressed without reducing the debt collection rate. That is to say, according to the present disclosure, costs for operations can be suppressed without reducing effects of operations of prompting users for predetermined actions. Also, according to the present embodiment, raising the debt collection rate while suppressing costs can be anticipated by increasing operations directed to users with high effects or risks.

Variations of Operation Conditions Output Processing

While an overview of the flow of operation conditions output processing has been described with reference to FIG. 10 in the above-described embodiment, the operation conditions output processing may be processed as follows in further detail.

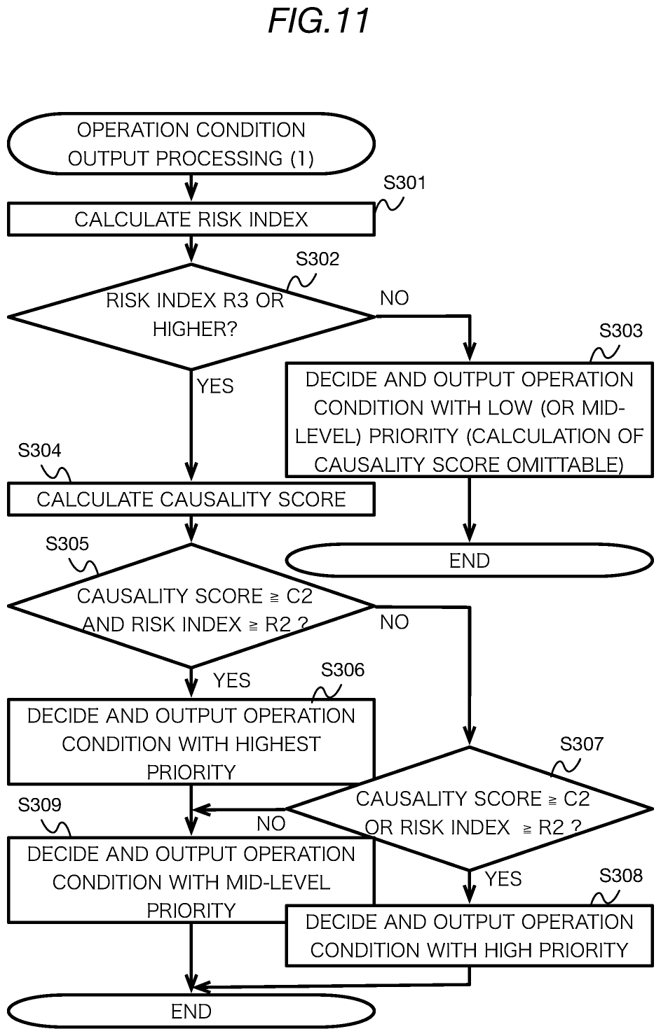

FIG. 11 is a flowchart showing the flow of the operation conditions output processing in the present embodiment, in a case of employing the determining technique according to cases (1) to (4), described with reference to FIG. 6. In the example shown in FIG. 11, it can be seen that in a case in which a risk index calculated by the risk estimating unit 23 regarding a user having a certain attribute (step S301) is lower than the threshold value R3 (third threshold value) (NO in step S302), calculation of the causality score by the effect estimating unit 21 is omitted, and operation conditions of which the priority is low (or mid-level) are decided and output (step S303).

In a case in which the risk index calculated regarding this user is the threshold value R3 (third threshold value) or higher (YES in step S302), the causality score is calculated (step S304), and in a case in which the causality score is the threshold value C2 or higher and the risk index is the threshold value R2 or higher (YES in step S305), operation conditions of which the priority is highest are decided and output (step S306), while in a case in which the causality score is the threshold value C2 or higher, or the risk index is the threshold value R2 or higher (YES in step S307), operation conditions of which the priority is high are decided and output (step S308). Note that in a case in which the causality score is lower than the threshold value C2 and the risk index is lower than the threshold value R2, operation conditions with mid-level priority are decided and output (step S309).

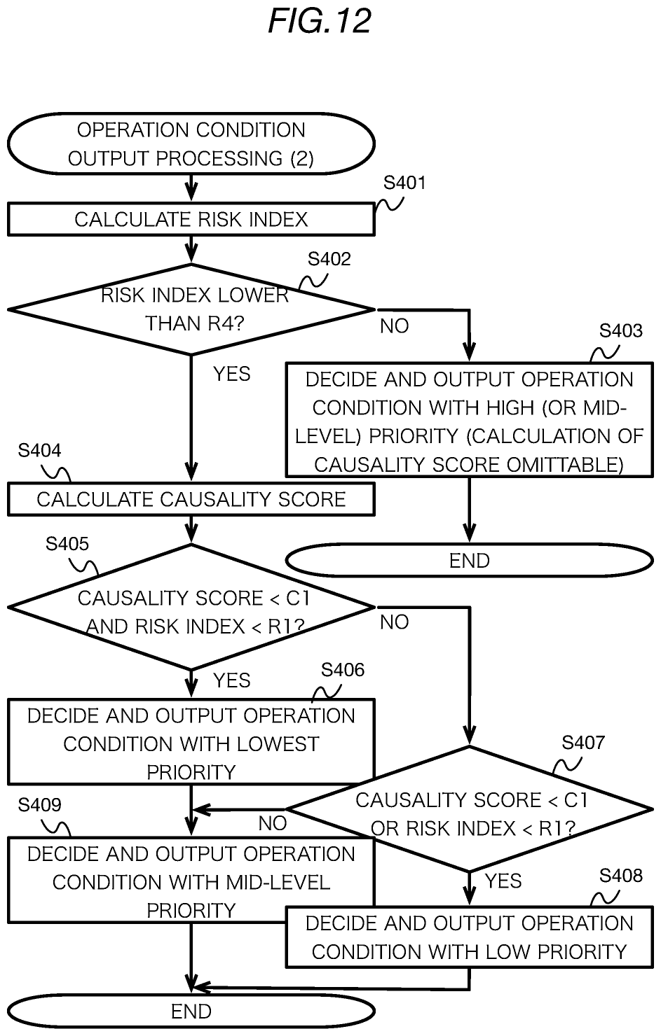

FIG. 12 is a flowchart showing the flow of the operation conditions output processing in the present embodiment, in a case of employing the determining technique according to cases (5) to (8), described with reference to FIG. 6. In the example shown in FIG. 12, it can be seen that in a case in which a risk index calculated by the risk estimating unit 23 regarding a user having a certain attribute (step S401) is the threshold value R4 or higher (NO in step S402), calculation of the causality score by the effect estimating unit 21 is omitted, and operation conditions of which the priority is high (or mid-level) are decided and output (step S403).

In a case in which the risk index calculated regarding this user is lower than the threshold value R4 (YES in step S402), the causality score is calculated (step S404), and in a case in which the causality score is lower than the threshold value C1 and the risk index is lower than the threshold value R1 (YES in step S405), operation conditions of which the priority is lowest are decided and output (step S406), while in a case in which the causality score is lower than the threshold value C1, or the risk index is lower than the threshold value R1 (YES in step S407), operation conditions of which the priority is low are decided and output (step S408). Note that in a case in which the causality score is the threshold value C1 or higher and the risk index is the threshold value R1 or higher, operation conditions of which priority is mid-level are decided and output (step S409).

Other Variations

Although an example in which the operation directed to the user is placing a telephone call has been described in the above-described embodiment, types of operations directed to users are not limited to placing a telephone call. For example, message transmission may be employed as a type of operation directed to the user. Note that the means for message transmission here is not limited, and an email system, short message service (SMS), or social networking service (SNS) message exchange services or the like may be used.

Also, although an example has been described in the above-described embodiment in which operation conditions are decided based on effects estimated with regard to one type of operation (telephone call), operation conditions may be decided based on effects estimated with regard to each of a plurality of types of operations (e.g., telephone call and message transmission). In this case, the effect estimating unit 21 estimates first effects that a first operation (e.g., telephone call) directed to a user to prompt the user to execute a predetermined action will have on the user to execute the action or not, and second effects that a second operation (e.g., message transmission) directed to the user to prompt the user to execute the predetermined action will have on the user to execute the action or not, and the condition outputting unit 25 outputs operation conditions regarding the user, based on the estimated first effects and second effects.

In this case, the machine learning model for estimating the effects of operations is also generated and updated for each type of operation. For example, in a case in which the first operation is placing a telephone call and the second operation is message transmission, an effects estimation machine learning model for a telephone call, and an effects estimation machine learning model for a message transmission may be generated and updated.

Further, in a case in which operation conditions are decided based on effects estimated for each of a plurality of types of operations, an operation of a type regarding which effects on the user are high may be selected from the plurality of types of operations. In this case, the condition outputting unit 25 outputs operation conditions including whether to perform the first operation or to perform the second operation with regard to the user, based on the first effects and the second effects that are estimated. More specifically, the first effects (causality score relating to the first operation) and the second effects (causality score relating to the second operation) obtained regarding the object user can be compared, and the type of operation of which the causality score is higher can be selected as an operation of a type regarding which effects on the user are high.

Also, an example has been described in the above-described embodiment in which the two axes of causality score indicating effects of operations and risk index indicating risk are used as evaluation axes for deciding operation conditions, but it is sufficient for at least effects of operations to be included in evaluation axes for deciding operation conditions in the technology according to the present disclosure, and other evaluation axes may be employed, and also three or more evaluation axes may be employed. For example, (1) a third index other than the risk index may be employed as an index combined with the causality score, (2) a third index may be employed in addition to the causality score and the risk index, and (3) three axes of the causality score for telephone call, the causality score for message transmission, and the risk index, may be employed.

Also, although an example has been described in the above-described embodiment in which the difference between the action execution rate of the sub-user group that received an operation and the action execution rate of the sub-user group that did not receive the operation is used as the causality score, a causality score calculated by another method may be used as the causality score. For example, at the time of generating and/or updating the machine learning model for effects estimation, the machine learning unit 24 may create the machine learning model based on training data, in which a score based on statistics relating to the execution rate of an action by users that made a predetermined reaction as to an operation, out of a plurality of users having a predetermined attribute, and statistics relating to the execution rate of the action by users that did not make the predetermined reaction, out of the plurality of users, is defined as the causality score regarding users having this attribute, for each user attribute. As an example, the causality score is calculated in this variation by an expression of “(debt collection rate in a case of the user performing a predetermined reaction)−(debt collection rate in a case of the user not performing the predetermined reaction)”. In this case, the condition outputting unit 25 may output conditions relating to the operation based on whether or not the user made a reaction, the contents thereof, and so forth, and a causality score according to the reaction. At this time, adjustment of the priority of operation conditions output by the condition outputting unit 25 may be performed using the relation between the causality score and the priority described with reference to FIG. 6.

Now, the predetermined reaction may be, for example, the user responding to the telephone call by pressing a dial key or the like, the user returning the telephone call that was placed and conversing with an operator, replying to a message, marking a message as read, or the like. Further, the content of the reaction may take into consideration a positive relay regarding payment, whether or not there is a reply regarding an intended date of payment, or the like. In a case in which the reaction by the user was made by voice, the emotions and so forth of the user can be determined based on the voice of the user, and determination can be made regarding whether or not the reaction was positive. Also, the priority of operation conditions for the next time may be adjusted from the emotions and so forth of the user determined based on the voice.

Also, the priority of operation conditions may be adjusted based on an element other that those described above. For example, the priority of operation conditions may be raised for users whose payment settings for credit card usage are revolving credit, installment payments, and so forth, as compared to single-payment users, and the priority of operation conditions may be raised for users whose credit card usage includes cash advance as compared to users regarding which cash advance is not included. Also, the priority of operation conditions can be adjusted in accordance with transaction data other than credit cards of the object user (i.e., balance data of account used for withdrawal of credit card usage amount, transaction history data in group banks, and so forth). Now, the condition outputting unit 25 may adjust various types of threshold values corresponding to various types of scores shown in FIG. 6, based on terms of usage of credit cards, for example.

What is claimed is:

1. An information processing device, comprising:
a memory; and
a processor coupled to the memory, the processor being configured to execute:
obtaining a first causality score indicating an effect that a predetermined operation has on a user, by inputting an attribute of the user to a first model;
obtaining a second causality score indicating the effect, by inputting the attribute of the user to a second model;
deciding a calibration function for calibration of the first causality score, based on the first causality score and the second causality score calculated for each of a plurality of users; and
deciding a third causality score indicating the effect on an object user, by applying the first causality score, which is calculated with regard to the object user, to the calibration function.

2. The information processing device according to claim 1, wherein the processor obtain the second causality score indicating the effect, by inputting the attribute of the user to the second model, the bias of which is smaller and the variance of which is greater than those of the first model.

3. The information processing device according to claim 1, wherein the processor decides the calibration function in which a difference between the third causality score obtained when applying the first causality score to the calibration function and the second causality score becomes smaller.

4. The information processing device according to claim 1, wherein the processor decides a function, which is a smooth function and also is a monotonic function, as the calibration function.

5. The information processing device according to claim 1, wherein the processor estimates the first causality score by using a machine learning model generated using a machine learning framework based on ensemble learning.

6. The information processing device according to claim 1, wherein the processor estimates the first causality score by using a machine learning model generated using a machine learning framework based on a gradient boosting decision tree.

7. The information processing device according to claim 1, wherein
the effect is an effect that a predetermined operation, which is directed to a user to prompt the user to execute a predetermined action, has on whether or not the user executes the action, and
the first model is created based on training data, in which a score based on statistics relating to an execution rate of the action by a user having received the operation, out of a plurality of users having a predetermined attribute, and statistics relating to the execution rate of the action by a user not having received the operation, out of the plurality of users, is defined as a score indicating the effect of the operation regarding the users having the attribute.

8. The information processing device according to claim 1, wherein, with respect to the second model generated by a method of assigning a plurality of users to each of a plurality of bins in a histogram in accordance with an attribute of each user and calculating, for each bin, a causality score corresponding to a user group assigned to the bin, the processor identifies the bin to which the object user corresponds, and estimates the causality score calculated for the bin, which is identified, as the second causality score of the object user.

9. The information processing device according to claim 8, wherein
the effect is an effect that a predetermined operation, which is directed to a user to prompt the user to execute a predetermined action, has on whether or not the user executes the action, and
the second model is generated by a method of calculating, for each bin, a causality score corresponding to a user group assigned to the bin, based on statistics relating to an execution rate of the action by a user having received the operation, out of a plurality of users having a predetermined attribute, and statistics relating to the execution rate of the action by a user not having received the operation, out of the plurality of users.

10. The information processing device according to claim 1, the processor further executes:
outputting a condition relating to the operation directed to the user, based on the effect that is estimated.

11. The information processing device according to claim 10, wherein the processor outputs a condition that yields higher priority with regard to the operation directed to a user for whom the effect that is estimated is higher.

12. A method executed by a computer, the method comprising:
obtaining a first causality score indicating an effect that a predetermined operation has on a user, by inputting an attribute of the user to a first model;
obtaining a second causality score indicating the effect, by inputting the attribute of the user to a second model;
deciding a calibration function for calibration of the first causality score, based on the first causality score and the second causality score calculated for each of a plurality of users; and
deciding a third causality score indicating the effect on an object user, by applying the first causality score, which is calculated with regard to the object user, to the calibration function.

13. A non-transitory computer-readable recording medium having recorded thereon a program, causing a computer to execute:
obtaining a first causality score indicating an effect that a predetermined operation has on a user, by inputting an attribute of the user to a first model;
obtaining a second causality score indicating the effect, by inputting the attribute of the user to a second model;
deciding a calibration function for calibration of the first causality score, based on the first causality score and the second causality score calculated for each of a plurality of users; and
deciding a third causality score indicating the effect on an object user, by applying the first causality score, which is calculated with regard to the object user, to the calibration function.
